(19) United States
(12) Patent Application Publication
(10) Pub. No.: US 2014/0194115 A1
(43) Pub. Date: Jul. 10, 2014

(54) METHOD FOR DISCOVERY IN DEVICE-TO-DEVICE COMMUNICATIONS AND APPARATUS FOR THE SAME

(71) Applicant: Electronics & Telecommunications Research Institute, Daejeon (KR)

(72) Inventors: Mi Jeong YANG, Daejeon (KR); Soon Yong LIM, Daejeon (KR); Kwang Ryul JUNG, Daejeon (KR); Hyung Deug BAE, Daejeon (KR); You Sun HWANG, Seoul (KR); Moon Soo JANG, Daejeon (KR); Hyeong Jun PARK, Daejeon (KR); Nam Hoon PARK, Daejeon (KR)

(73) Assignee: Electronics & Telecommunications Research Institute, Daejeon (KR)

(21) Appl. No.: 14/149,077

(22) Filed: Jan. 7, 2014

(30) Foreign Application Priority Data
Jan. 8, 2013 (KR) 10-2013-0002012
Jan. 7, 2014 (KR) 10-2014-0001658

(51) Int. Cl. H04W 52/02; H04W 48/14; H04W 72/04; H04W 4/00

(52) U.S. Cl. CPC H04W 52/0212; H04W 4/008; H04W 48/14; H04W 72/044
USPC 455/426.1

(57) ABSTRACT

A method for discovery in device-to-device communications and an apparatus for the same are disclosed. The method performed in a device-to-device server supporting device-to-device discovery between a discovery terminal and a discoverable terminal may include receiving a device-to-device discovery participation message from the discoverable terminal, requesting a gateway to measure a proximity between the discovery terminal and the discoverable terminal, receiving a proximity measurement result from the gateway, and requesting the discovery terminal and the discoverable terminal to initiate a procedure of device-to-device discovery when the proximity measurement result satisfies a predetermined threshold. Thus, the procedure of device-to-device discovery may be performed efficiently.

### CROSS-REFERENCE TO RELATED APPLICATIONS

This application claims priorities to Korean Patent Application Nos. 10-2013-0002012 filed on Jan. 8, 2013, and 10-2014-0001658 filed on Jan. 7, 2014 in the Korean Intellectual Property Office (KIPO), the entire contents of which are hereby incorporated by references.

### BACKGROUND

1. Field

Example embodiments of the present invention relate to device-to-device communications, and more specifically, a method for efficient discovery which is used to discover a terminal performing device-to-device communications, and an apparatus for the same.

2. Description of Related Art

A normal cellular communication method by which two terminals (a first terminal and a second terminal) transmit or receive data or control information in a cellular mobile communication environment is performed via a base station. In other words, when the first terminal has data or control information to be transmitted to the second terminal, the first terminal transmits the data or the control information to a base station (a first base station) that the first terminal belongs to. Then, the information is delivered to a second base station that the second terminal belongs to. As a last step of cellular communication, the second base station transmits the information to the second terminal. In this case, the first base station and the second base station may be the same base stations or may be different base stations.

On the other hand, device-to-device communication (hereinafter also referred to as D2D communication) means a communication scheme of performing direct data transmission and reception between two adjacent terminals, not via a base station. In other words, two terminals perform communication as a data source and a data destination, respectively.

In order to perform device-to-device communications, a discovery terminal should discover a discoverable terminal located adjacently to the discovery terminal through a discovery procedure. If the discoverable terminal is located adjacently to the discovery terminal, the discovery terminal may discover the discoverable terminal rapidly. However, if the discoverable terminal is located far from the discovery terminal, it takes much time for the discovery terminal to discover the discoverable terminal so that power consumption of the discovery terminal may increase severely.

### SUMMARY

Accordingly, example embodiments of the present invention are provided to substantially obviate one or more problems due to limitations and disadvantages of the related art.

Example embodiments of the present invention provide a method for device-to-device discovery which is performed based on proximity between terminals.

Example embodiments of the present invention also provide an apparatus for performing device-to-device discovery based on proximity between terminals.

In some example embodiments, there is provided a method for device-to-device discovery, performed in a device-to-device server supporting device-to-device discovery between a discovery terminal and a discoverable terminal, comprising receiving a device-to-device discovery participation message from the discoverable terminal, requesting a gateway to measure proximity between the discovery terminal and the discoverable terminal, receiving a proximity measurement result from the gateway, and requesting the discovery terminal and the discoverable terminal to initiate a procedure of device-to-device discovery when the proximity measurement result satisfies a predetermined threshold.

Here, the method may further comprise allocating a physical channel for device-to-device discovery for the discovery terminal and the discoverable terminal after the requesting the discovery terminal and the discoverable terminal to initiate a procedure of device-to-device discovery.

Here, the device-to-device discovery participation message may indicate that the discoverable terminal participates in the procedure of device-to-device discovery requested by the discovery terminal

Here, the gateway may be a Packet Data Network (PDN) gateway (PGW).

Here, the proximity may be measured based on received signal strength of reference signals transmitted and received between the discovery terminal and the discoverable terminal.

Here, the predetermined threshold may be determined based on a minimal distance which makes device-to-device communications between the discovery terminal and the discoverable terminal possible.

In other example embodiments, there is provided a method for device-to-device discovery, performed in a device-to-device server supporting device-to-device discovery between a discovery terminal and a discoverable terminal, comprising receiving device-to-device communication initiation request messages from the discovery terminal and the discoverable terminal, transmitting a device-to-device communication configuration request message requesting a gateway to configure device-to-device communications between the discovery terminal and the discoverable terminal, and receiving a device-to-device communication configuration response message indicating a completion of configuration of device-to-device communications between the discovery terminal and the discoverable terminal from the gateway when a proximity measurement result satisfies a predetermined threshold.

Here, the device-to-device communication initiation request messages may be received from the discovery terminal which recognized the discoverable terminal and from the discoverable terminal which recognized the discovery terminal

Here, the gateway may be a Packet Data Network (PDN) gateway (PGW) Here, the device-to-device communication configuration request messages may include a network identifier of the discovery terminal and a network identifier of the discoverable terminal

Here, the proximity may be measured based on received signal strength of reference signals transmitted and received between the discovery terminal and the discoverable terminal

Here, the proximity may be measured based on positional information of the discovery terminal and positional information of the discoverable terminal

Here, the predetermined threshold may be determined based on a minimal distance which makes device-to-device communications between the discovery terminal and the discoverable terminal possible.

In still other example embodiments, there is provided a method for measuring proximity between terminals, performed in a base station, comprising allocating radio resources for transmitting a reference signal for measuring proximity to a first terminal, allocating radio resources for receiving the reference signal for measuring proximity to a second terminal, obtaining information on measurement result of the reference signal from the second terminal, and determining whether to start device-to-device communications between the first terminal and the second terminal based on the information on measurement result of the reference signal.

Here, the base station may allocate radio resources for transmitting the reference signal for measuring proximity based on a request of a device-to-device server.

Here, the information on measurement result of the reference signal may include the received signal strength of the reference signal.

Here, the device-to-device communications between the first terminal and the second terminal may be determined to be started when the received signal strength of the reference signal is equal to or above a predetermined threshold.

Here, the device-to-device communications between the first terminal and the second terminal may be determined to be released when the received signal strength of the reference signal is below a predetermined threshold.

Here, the predetermined threshold may be a minimal signal strength which makes the device-to-device communications between the first terminal and the second terminal possible

### BRIEF DESCRIPTION OF THE DRAWINGS

Example embodiments of the present invention will become more apparent by describing in detail example embodiments of the present invention with reference to the accompanying drawings, in which:

FIG. 1 is a conceptual diagram to illustrate a structure of a network for device-to-device communications;

FIG. 2 is a conceptual diagram to illustrate a structure of a terminal for device-to-device communications;

FIG. 3 is a flow chart to illustrate a first step of a method for restricted-type discovery according to an example embodiment of the present invention;

FIG. 4 is a flow chart to illustrate a second step of a method for restricted-type discovery according to an example embodiment of the present invention;

FIG. 5 is a flow chart to illustrate a third step of a method for restricted-type discovery according to an example embodiment of the present invention;

FIG. 6 is a flow chart to illustrate a fourth step of a method for restricted-type discovery according to an example embodiment of the present invention;

FIG. 7 is a flow chart to illustrate a procedure of resource release in a method for restricted-type discovery according to an example embodiment of the present invention;

FIG. 8 is a flow chart to illustrate a procedure of configuring device-to-device connection for restricted-type discovery according to an example embodiment of the present invention;

FIG. 9 is a flow chart to illustrate a procedure of measuring and reporting proximity according to an example embodiment of the present invention;

FIG. 10 is a flow chart to illustrate a first step of a procedure of configuring device-to-device communications according to an example embodiment of the present invention;

FIG. 11 is a flow chart to illustrate a second step of a procedure of configuring device-to-device communications according to an example embodiment of the present invention;

FIG. 12 is a flow chart to illustrate a procedure of releasing D2D communications initiated by a user according to an example embodiment of the present invention;

FIG. 13 is a flow chart to illustrate a procedure of releasing D2D communications initiated by a base station according to an example embodiment of the present invention;

FIG. 14 is a flow chart to illustrate a procedure of releasing D2D bearer according to an example embodiment of the present invention;

FIG. 15 is a flow chart of a first step of an open-type discovery procedure according to an example embodiment of the present invention;

FIG. 16 is a flow chart of a second step of an open-type discovery procedure according to an example embodiment of the present invention;

FIG. 17 is a flow chart of a third step of an open-type discovery procedure according to an example embodiment of the present invention; and

FIG. 18 is a flow chart to illustrate a procedure of configuring D2D connection in an open-type discovery according to an example embodiment of the present invention.

### DETAILED DESCRIPTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

According to rapid advances of communication devices supporting new services such as smartphones, tablets, and the like, traffic amount of communication networks is increasing rapidly. Also, if machine-type communications enabling communications between human and devices and between devices, such as internet of things (IoT), are widely activated, traffics toward base stations are expected to be increased to the extent that current base stations cannot deal with.

Therefore, device-to-device communications (hereinafter, referred as ‘D2D’) between terminals are now considered as a method enhancing performances of conventional cellular networks with an affordable cost. In a technology of device-to-device communication using cellular communication network, terminals may transmit and receive data directly without intervention of base stations. In this case, since the conventional cellular communication manner is used without being changed, higher security, wider coverage, and higher data throughput may be achieved rather than other communication manners such as a WiFi direct, a ZigBee, and a Bluetooth.

In order to use the above device-to-device communication efficiently, a method of discovering a terminal located adjacent or a terminal transmitting advertisement to unspecified plurality of terminals is needed. In addition, a method of discovery consuming minimum power is needed. Also, changes on the conventional cellular networks and terminals should be minimized.

The term “network” or “communication network” used in this specification may include a mobile internet such as a Wireless Fidelity (WIFI), a Wireless Broadband Internet (WiBro), and a World Interoperability for Microwave Access (WiMax). Also, it may include 2G cellular networks such as a Global System for Mobile communication (GSM) and a Code Division Multiple Access (CDMA), 3G cellular networks such as a Wideband Code Division Multiple Access (WCDMA) and a CDMA2000. Also, it may include 3.5G cellular network such as a High Speed Downlink Packet Access (HSDPA) and a High Speed Uplink Packet Access (HSUPA). Also, it may include 4G or beyond 4G cellular network such as a Long Term Evolution (LTE) and a LTE-Advanced.

A “terminal” used in this disclosure may refer to user equipment (UE), a mobile station (MS), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, etc. Various examples of the terminal may include a cellular phone, a smartphone having a wireless communication function, a personal digital assistant (PDA) having a wireless communication function, a wireless modem, a portable computer having a wireless communication function, a photographing device such as a digital cameras having a wireless communication function, a gaming device having a wireless communication function, a music storage and reproduction home appliance have a wireless communication function, an Internet home appliance capable of wireless Internet access and browsing, and a portable unit or a terminal having a combination of such functions.

A “cell” or a “base station” used in this disclosure generally refers to a fixed or mobile point that communicates with a terminal and may be a term for collectively referring to a base station, node-B, eNode-B, a BTS (base transceiver system), an access point, a transmit point, a receive point, an RRH (Remote Radio Head), an RRE (Remote Radio Element), an RRU (Remote Radio Unit), a relay, a femto-cell, etc.

In device-to-device communications, a terminal may transmit discovery information to neighbor terminals in order to notify its existence to the neighbor terminals. Also, the terminal may recognize existences of the neighbor terminals by receiving discovery information of the neighbor terminals. For device-to-device discovery, a functional entity may be needed for assigning and managing discovery information for the terminals. Hereinafter, the functional entity for assigning and managing discovery information for the terminals may be referred as a device-to-device server (or, D2D server).

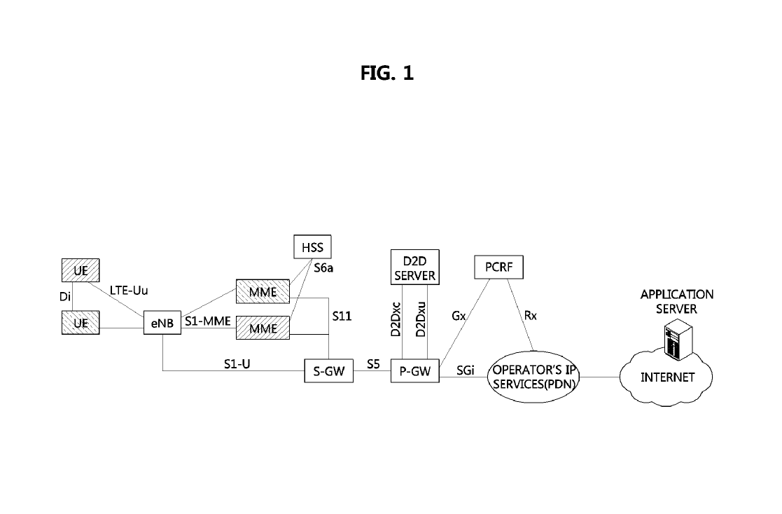

FIG. 1 is a conceptual diagram to illustrate a structure of a network for device-to-device communications.

Referring to FIG. 1, a device-to-device server may be connected to a Packet Data Network gateway (PGW) via an interface D2Dxc and an interface D2Dxu. The interface D2Dxc is a control interface used to perform, via the PGW, authentication of terminals, measurement/allocation/release of physical channels for device-to-device discovery, operation/release of procedures for device-to-device communications based on user request, and so on. The interface D2Dxu is a data interface used to perform, via the PGW and interfaces such as S5, S1-U, and LTE-Uu, setting of relations between terminals, to allocation/management of discovery information, and management of connection/release requests from users, etc.

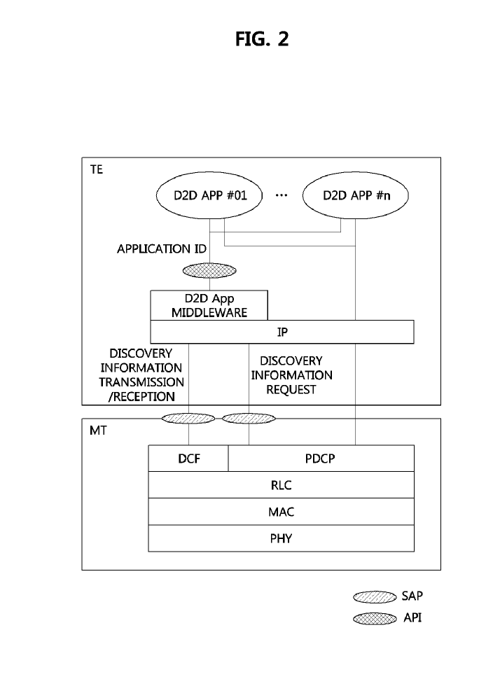

FIG. 2 is a conceptual diagram to illustrate a structure of a terminal for device-to-device communications.

Referring to FIG. 2, a terminal for device-to-device communications may comprise at least one device-to-device application (D2D APP #01, . . . , D2D APP #n), and an IP layer having a protocol structure for conventional cellular communications. Meanwhile, setting of relations between terminals, allocation/management of discovery information, and transfer of user requests may be performed via a device-to-device application (D2D APP) middleware. That is, above operations are performed via a path comprising the device-to-device application, the D2D application middleware, and the device-to-device server of a cellular communication network. In addition, the D2D application middleware may perform functions of transmitting and receiving discovery information, and filtering discovery information.

In device-to-device communications, a discovery procedure of a terminal may be classified into an open-type discovery and a restricted-type discovery. The open-type discovery may be a discovery procedure in which unspecified terminals (users) participate, and the restricted-type discovery may be a discovery procedure in which specified terminals (users) participate. Here, the specified terminals (users) may mean terminals (users) which agreed upon performing discovery between them in advance. For example, the specified users may be friends known to each other. The discovery using a Social Networking Application (SNA) may be regarded as an example of the restricted type discovery.

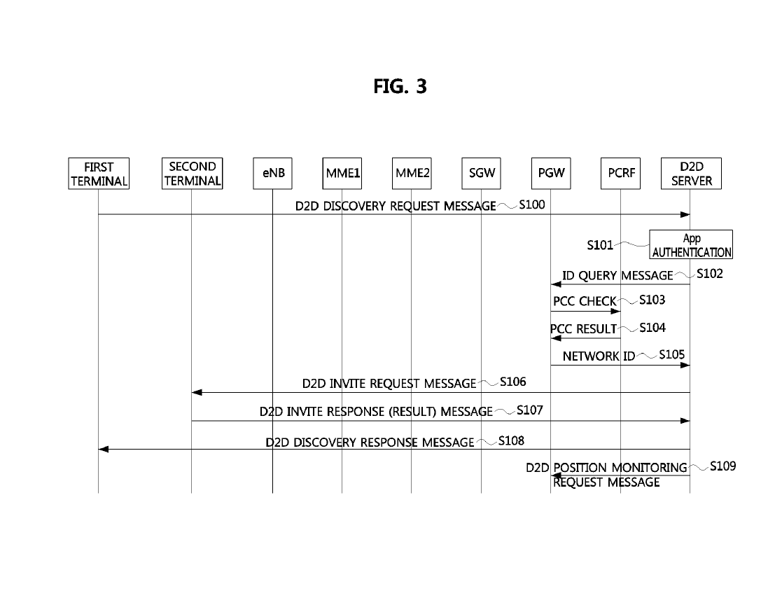

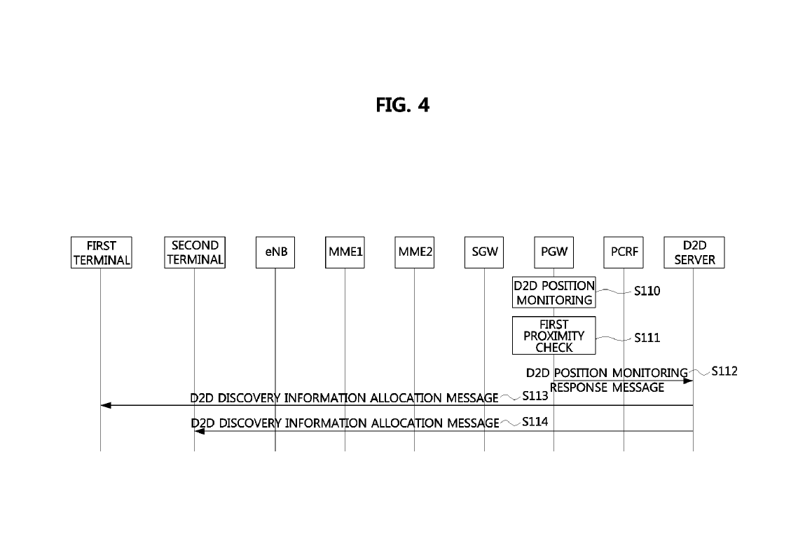

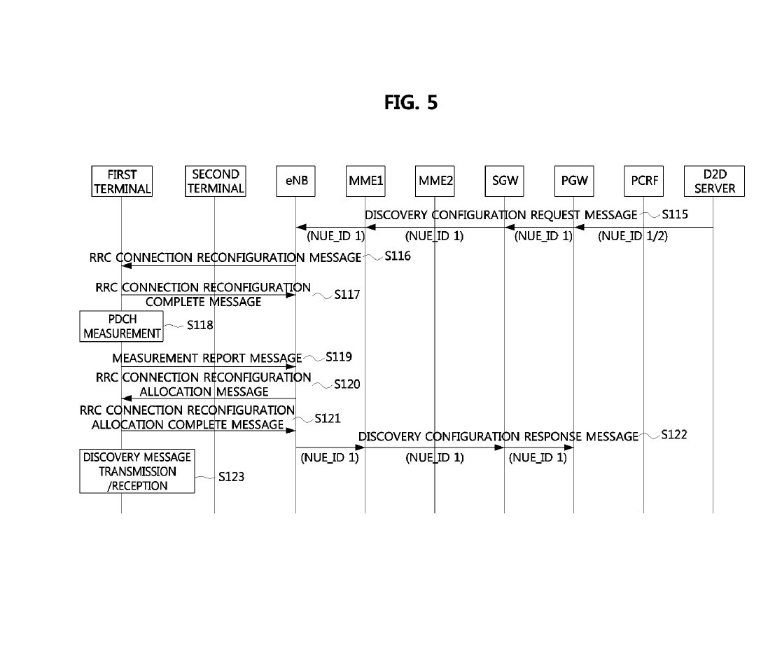

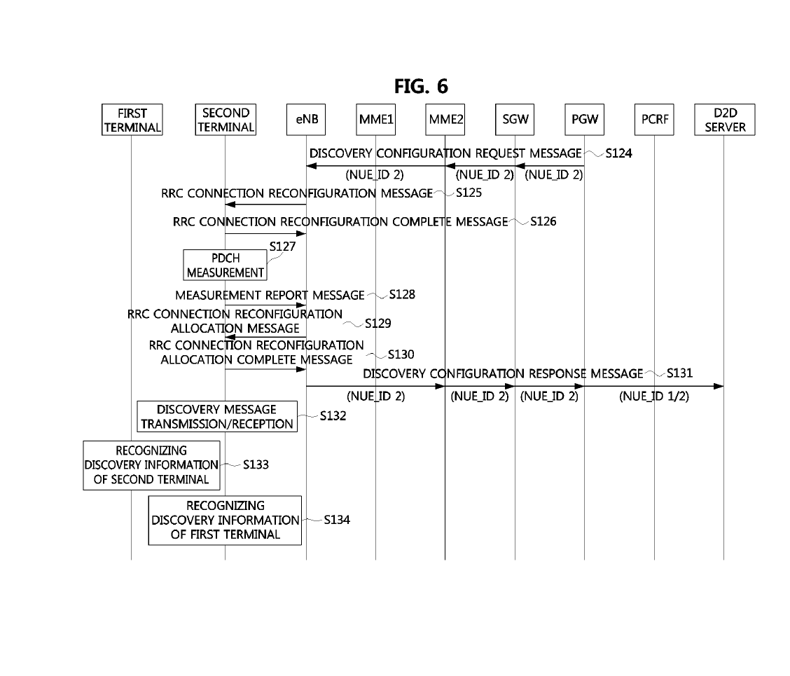

FIG. 3 is a flow chart to illustrate a first step of a method for restricted-type discovery according to an example embodiment of the present invention, and FIG. 4 is a flow chart to illustrate a second step of a method for restricted-type discovery according to an example embodiment of the present invention, and FIG. 5 is a flow chart to illustrate a third step of a method for restricted-type discovery according to an example embodiment of the present invention, and FIG. 6 is a flow chart to illustrate a fourth step of a method for restricted-type discovery according to an example embodiment of the present invention.

Referring to FIGS. 3 to 6, a first terminal may be connected to a first mobility management entity (MME), and a second terminal may be connected to a second MME. Also, the first terminal and the second terminal may be connected to the same MME. The first terminal and the second terminal may be connected to the same base station (eNB) or different base stations.

The first terminal may transmit a D2D discovery request message to a D2D server for discovery of the second terminal at S100. The D2D discovery request message may include an identifier of the first terminal, an identifier of the second terminal, an identifier of application, and so on. For example, the D2D discovery request message may include a telephone number of the first terminal, a telephone number of the second terminal, a social network service (SNS) information, and so on. When the D2D server receives the D2D discovery request message, the D2D server may perform authentication on an application corresponding to the identifier of application included in the D2D discovery request message at S101.

The D2D server may obtain, from a PGW, a network identifier NUE_ID1 of the first terminal and a network identifier NUE_ID2 of the second terminal. In other words, the D2D server may transmit an identifier (ID) query message to the PGW as S 102. The ID query message may include an identifier of the first terminal and an identifier of the second terminal. The PGW may perform Policy Control and Charging (PCC) checks on the first terminal and the second terminal according to the ID query message from the D2D server by interworking with a Policy Control and Charging rules function (PCRF) at S103 and S104. Then, the PGW may transmit the network identifier of the first terminal and the network identifier of the second terminal to the D2D server at S105. Here, the network identifier may mean an identifier which can identify a terminal within a network such as an international mobile subscriber identity (IMSI), an IP address, and the like.

The D2D server may transmit a D2D invite request message to the second terminal for identifying a user of the second terminal at S106. The D2D invite request message may include the identifier of the first terminal, an identifier of application, and the like. When the second terminal receives the D2D invite request message and desires to participate in the restricted-type discovery, the second terminal may transmit a D2D invite response (result) message to the D2D server at S107 in response to the D2D invite request message. When the D2D server receives the D2D invite response (result) message, the D2D server may transmit a D2D discovery response message to the first terminal in response to the D2D discover request message at S108. That is, D2D discovery response message may indicate that the second terminal decided to participate in the restricted-type discovery requested by the first terminal.

After the D2D server identifies that the first terminal and the second terminal participate in the restricted-type discovery, the D2D server may transmit a D2D position monitoring request message to the PGW for a first proximity check at S109. The D2D position monitoring request message may include the network ID of the first terminal and the network ID of the second terminal, and so on.

The PGW may perform monitoring on positions of the first terminal and the second terminal according to the request from the D2D server at S110, and may check proximity between the first terminal and the second terminal based on a result of the monitoring at S111. Here, a method of monitoring and checking proximity may be explained in detail later. The PGW may transmit a D2D position monitoring response message to the D2D server at S112.

The D2D location monitoring response message may include information on checked proximity between the first terminal and the second terminal, and may include the network ID of the first terminal and the network ID of the second terminal, and so on.

The D2D server may determine whether the first terminal and the second terminal are located within a distance in which device-to-device communications between them are possible. When the first terminal and the second terminal are located within a distance in which device-to-device communications between them are possible, the D2D server may transmit a D2D discovery information allocation message to each terminal at S113 and S114. The D2D discovery information allocation message may include discovery information for the first terminal and discovery information for the second terminal. In other words, the D2D server may assign a D2D discovery identifier (ID) to each terminal by transmitting the D2D discovery information allocation message to each terminal.

On the contrary, when the first terminal and the second terminal are not located within a distance in which device-to-device communications between them are possible, the D2D server may not perform device-to-device discovery procedures. That is, the D2D server does not transmit the D2D discovery information allocation message to each terminal.

Here, although an example in which the step S113 is performed before the step S114 is performed is shown in FIG. 4, performing order of the steps S113 and S114 is not limited to the above example. That is, the step S114 may be performed before the step S113, or the steps S113 and S114 may be performed at the same time.

The first terminal and the second terminal may identify that they can perform device-to-device discovery when the first terminal and the second terminal receives the D2D discovery information allocation message respectively from the D2D server.

Then, allocation of resources for device-to-device discovery may be started. The D2D server may transmit a D2D discovery configuration request message including the network ID of the first terminal and the network ID of the second terminal to the PGW. The PGW which receives the D2D discovery configuration request message may transmit the D2D discovery configuration request message including the network ID of the first terminal to a serving gateway (SGW). In other words, the D2D discovery configuration request message including the network ID of the first terminal may be transferred to a base station sequentially through the SGW and a Mobility Management Entity (MME) at S115.

When the base station (eNB) receives the D2D discovery configuration request message including the network ID of the first terminal, the base station may transmit a Radio Resource Control (RRC) connection reconfiguration message to the first terminal at S116. That is, the base station may request the first terminal to measure state of Physical Discovery Channel (PDCH) of a current cell for allocating PDCH resources to the first terminal by transmitting the RRC connection reconfiguration message to the first terminal Here, the PDCH may be used for discovery procedures of device-to-device communications.

The first terminal may transmit a RRC connection reconfiguration complete message to the base station in response to the RRC connection reconfiguration message at S117, and measure state of PDCH of a current cell at S118. The first terminal may transmit a measurement report message including a measured PDCH state information to the base station at S119. The base station may select a PDCH for the first terminal based on the PDCH state information and transmit a RRC connection reconfiguration allocation message including information on the selected PDCH to the first terminal as S120.

The first terminal may transmit a RRC connection reconfiguration allocation complete message in response to the RRC connection reconfiguration allocation message to the base station at S121. When the base station receives the RRC connection reconfiguration allocation complete message, the base station may transmit a discovery configuration response message including the network ID of the first terminal to a first MME. That is, the discovery configuration response message may be transmitted to the PGW via the first MME and the SGW at S122. Also, when the RRC connection reconfiguration allocation complete message is transmitted, the first terminal may broadcast a message including discovery information through the PDCH allocated for the first terminal, and receive discovery information transmitted from other terminal through PDCH at S123.

Meanwhile, a procedure of device-to-device discovery resource allocation for the first terminal and a procedure of device-to-device discovery resource allocation for the second terminal may be performed at the same time. In other words, when the D2D configuration request message is received from the D2D server, the PGW may transmit the D2D discovery configuration request message including the network ID of the second terminal to the SGW. That is, the D2D discovery configuration request message including the network ID of the second terminal may be transmitted to the base station via the SGW and a second MME at S124.

The base station may transmit a RRC connection reconfiguration message to the second terminal when the base station receives the discovery configuration request message including the second terminal network ID at S125. That is, the base station may request the second terminal to measure state of PDCH of a current cell for allocating PDCH resources by transmitting the RRC connection reconfiguration message. Here, the PDCH may be used for a discovery procedure of device-to-device communications.

The second terminal may transmit a RRC connection reconfiguration complete message to the base station in response to the RRC connection reconfiguration message at S126, and measure state of PDCH of a current cell at S127. The second terminal may transmit a measurement report message including measured PDCH state information to the base station at S128. The base station may select a PDCH for the second terminal based on the PDCH state information and transmit a RRC connection reconfiguration allocation message including information on the selected PDCH to the second terminal as S129.

The second terminal may transmit a RRC connection reconfiguration allocation complete message in response to the RRC connection reconfiguration allocation message to the base station at S130. When the base station receives the RRC connection reconfiguration allocation complete message, the base station may transmit a D2D discovery configuration response message including the network ID of the second terminal to a second MME. That is, the D2D discovery configuration response message may be transmitted to the PGW via the second MME and the SGW. Meanwhile, the PGW may transmit a D2D discovery configuration response message including the network IDs for the first terminal and the second terminal to the D2D server when the network IDs for the first terminal and the second terminal are received through the D2D discovery configuration response message at S131.

Also, when the RRC connection reconfiguration allocation complete message is transmitted, the second terminal may broadcast a message including discovery information through the PDCH allocated for the second terminal, and receive discovery information transmitted from other terminal through PDCH at S132.

The first terminal may recognize the second terminal by receiving discovery information of the second terminal transmitted through the PDCH allocated for the first terminal at S133. Similarly, the second terminal may recognize the first terminal by receiving discovery information of the first terminal transmitted through the PDCH allocated for the second terminal at S134.

Here, the first terminal may not transmit and receive discovery information before the second terminal enters into a range in which device-to-device communications are possible by performing the first proximity check procedure. Accordingly, the first terminal may save power consumption for device-to-device communications. In order to check proximity between the first terminal and the second terminal, the PGW may use a cell ID, information on tracking area, information on routing area, and information on discovery area which is defined for device-to-device discovery, and may interwork with a location server.

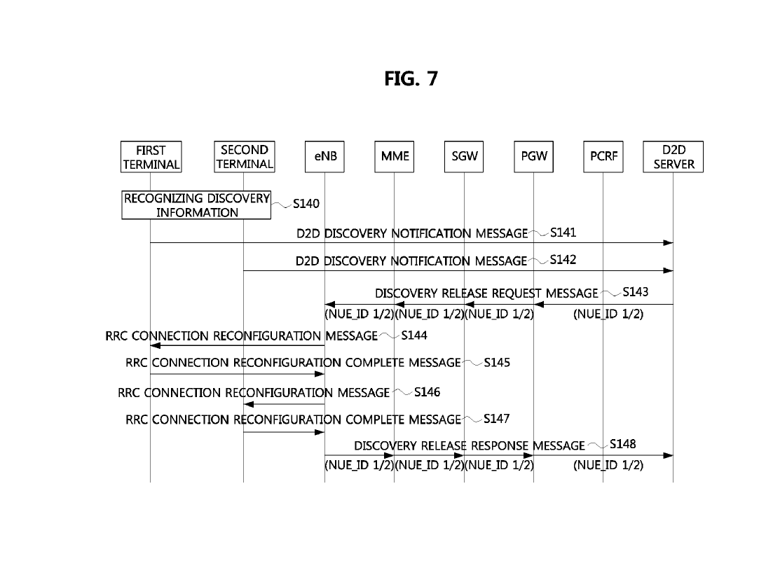

FIG. 7 is a flow chart to illustrate a procedure of resource release in a method for restricted-type discovery according to an example embodiment of the present invention.

Referring to FIG. 7, the device-to-device server may release a discovery procedure (that is, release of resources allocated for discovery) when there is a request from a terminal. The release of the discovery procedure may be performed by a request of at least one terminal.

The first terminal and the second terminal can request release of the discovery procedure after they recognize existence of each other (that is, after they recognize discovery information of each other). At this time, a release of discovery procedure may be performed by a request of the first terminal or the second terminal. In other words, the first terminal may request release of discovery procedure by transmitting a D2D discovery notification message to the D2D server at S141. Similarly, the second terminal may request release of discovery procedure by transmitting a D2D discovery notification message to the D2D server at S142.

The D2D server may transmit a D2D discovery release request message to the PGW when the D2D discovery notification message is received from at least one of the first terminal and the second terminal. The D2D discovery release request message may be transmitted to the base station sequentially through the PGW, the SGW, and the MME at S143. In other words, the D2D server may request the base station to release discovery procedure (resources allocated for discovery) for the first terminal and the second terminal by transmitting the D2D discovery release request message. Here, the D2D discovery release request message may include the network ID of the first terminal and the network ID of the second terminal.

The base station may transmit a RRC connection reconfiguration message to the first terminal when the base station receives the D2D discovery release request message at S144. That is, the base station may request the first terminal to release discovery procedure by transmitting the RRC connection reconfiguration message.

The first terminal may transmit a RRC connection reconfiguration complete message in response to the RRC connection reconfiguration message to the base station at S145. Then, the first terminal may stop transmitting messages including discovery information through PDCH, and may stop receiving discovery information transmitted from other terminal. Also, an appropriate release cause value may be transferred to an application of the first terminal.

Also, the base station may transmit a RRC connection reconfiguration message to the second terminal when the base station receives the D2D discovery release request message at S146. That is, the base station may request the second terminal to release discovery procedure by transmitting the RRC connection reconfiguration message.

The second terminal may transmit a RRC connection reconfiguration complete message in response to the RRC connection reconfiguration message to the base station at S147. Then, the second terminal may stop transmitting messages including discovery information through PDCH, and may stop receiving discovery information transmitted from other terminal. Also, an appropriate release cause value may be transferred to an application of the second terminal.

When the RRC connection reconfiguration complete message is received, the base station may recover PDCHs allocated for each terminal and transmit a D2D discovery release response message in response to the D2D discovery release request message to the MME. The D2D discovery release response message may be transmitted to the D2D server sequentially through the MME, the SGW, and the PGW at S148. The discovery release response message may include the network ID of the first terminal and the network ID of the second terminal. The D2D server may recover discovery information allocated for each terminal when the D2D discovery release response message is received.

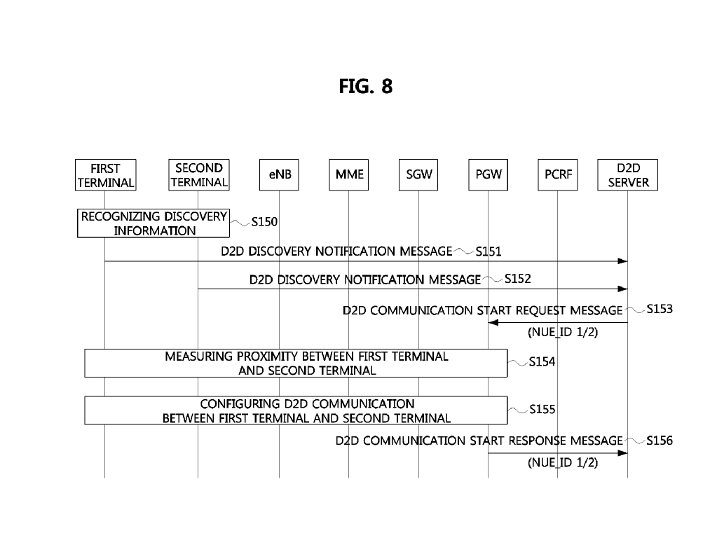

FIG. 8 is a flow chart to illustrate a procedure of configuring device-to-device connection for restricted-type discovery according to an example embodiment of the present invention.

The D2D server may configure a device-to-device communication when there is a request from a terminal. The configuration of the device-to-device communication may be performed by requests of both terminals which will perform device-to-device communications.

The first terminal and the second terminal can request configuration of device-to-device communication after they recognize existence of each other (that is, after they recognize discovery information of each other). In other words, the first terminal may request configuration of device-to-device communication by transmitting a D2D discovery notification message to the D2D server at S151. Similarly, the second terminal may request configuration of device-to-device communication by transmitting a D2D discovery notification message to the D2D server at S152.

When the D2D discovery notification message is received, the first terminal may instruct the PGW to configure a device-to-device communication between the first terminal and the second terminal by transmitting a D2D communication start request message to the PGW at S153. The D2D communication start request message may include the network ID of the first terminal, the network ID of the second terminal, and so on.

When the D2D communication start request message is received, the PGW may measure proximity between the first terminal and the second terminal at S154. The detail method of measuring proximity will be explained later.

If the measured proximity meets a preconfigured criteria (that is, the first terminal and the second terminal are located within a distance in which device-to-device communications are possible), the PGW may configure a device-to-device communication between the first terminal and the second terminal at S155. The detail method of configuring the device-to-device communication will be explained later. On the contrary, if the measured proximity does not meet the preconfigured criteria (that is, the first terminal and the second terminal are not located within a distance in which device-to-device communications are possible), the PGW does not configure a device-to-device communication between the first terminal and the second terminal.

After the configuration of the device-to-device communication between the first terminal and the second terminal is completed, the PGW may transmit a D2D communication start response message in response to the D2D communication start request message at S156. In other words, the PGW may notify the D2D server the completion of configuration of device-to-device communication between the first terminal and the second terminal by transmitting the D2D communication start response message. The D2D communication start response message may include the network ID of the first terminal network ID, the network ID of the second terminal network ID, and so on.

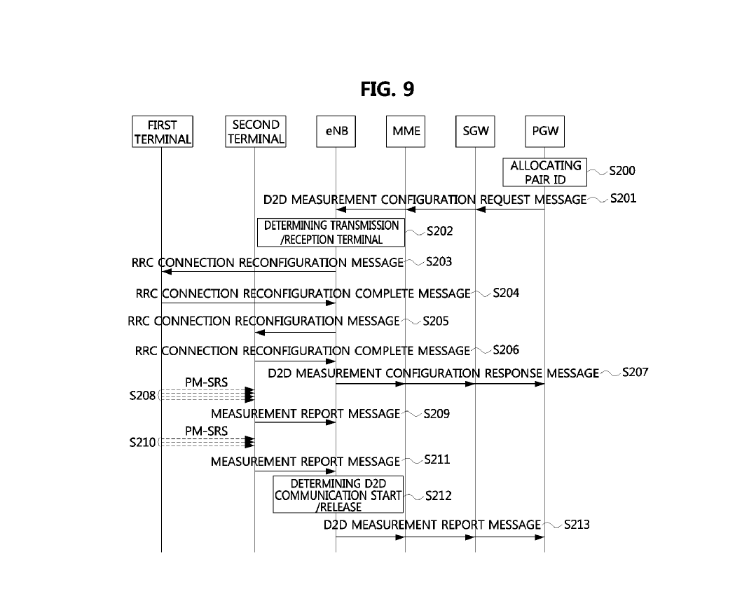

FIG. 9 is a flow chart to illustrate a procedure of measuring and reporting proximity according to an example embodiment of the present invention.

Referring to FIG. 9, the PGW may perform a second measurement on proximity between the first terminal and the second terminal. The first measurement may be performed through the steps S110 and S111 depicted in FIG. 4, and the second measurement may mean the step S154 depicted in FIG. 8.

The PGW may perform the second proximity measurement based on the result of the first proximity measurement and information on network load and traffic volume. First, the PGW may notify the start of proximity measurement procedure by transmitting a D2D measurement configuration request message to the SGW. The D2D measurement configuration request message may be transmitted to the base station sequentially through the SGW and the MME at S201. The D2D measurement configuration request message may include the network ID of the first terminal, the network ID of the second terminal, an identifier of a device-to-device pair (pair ID), and so on. If a pair identifier has not been assigned to the first terminal and the second terminal, the PGW may assign a pair identifier for the first terminal and the second terminal, and may perform the second proximity measurement.

When the D2D measurement configuration request message is received, the base station may determine a terminal which will transmit a signal for measurement (for example, PM-SRS) and a terminal which will receive the signal for measurement at S202. In other words, the base station may determine the first terminal as a transmit terminal and the second terminal as a receive terminal. On the contrary, the base station may determine the second terminal as a transmit terminal and the first terminal as a receive terminal. Hereinafter, an example in which the first terminal is a transmit terminal and the second terminal is a receive terminal will be explained.

The base station may transmit a RRC connection reconfiguration message to the first terminal which will transmit the signal for measurement at S203. The RRC connection reconfiguration message may include configuration information needed for transmitting the signal for measurement. For example, the RRC connection reconfiguration message may include information needed for transmitting PM-SRS. The first terminal may transmit a RRC connection reconfiguration complete message in response to the RRC connection reconfiguration message to the base station at S204.

On the other hand, the base station may transmit a RRC connection reconfiguration message to the second terminal which will receive the signal for measurement at S205. The RRC connection reconfiguration message may include configuration information needed for receiving the signal for measurement. The second terminal may transmit a RRC connection reconfiguration complete message in response to the RRC connection reconfiguration message to the base station at S206.

The base station may identify that measurement of proximity between the first terminal and the second terminal is performed when the RRC connection reconfiguration complete messages are received from both the first terminal and the second terminal. Accordingly, the base station may transmit a D2D measurement configuration response message in response to the D2D measurement configuration request message to the MME. The D2D measurement configuration response message may be transmitted to the PGW sequentially through the MME and the SGW at S207. The D2D measurement configuration response message may include a pair ID for the first terminal and the second terminal.

After the first terminal transmits the RRC connection reconfiguration complete message, the first terminal may transmit the signal for measurement (for example, PM-SRS) to the second terminal at S208 and S210. The second terminal may receive the signal for measurement transmitted from the first terminal, and transmit a measurement report message including result of receiving the signal for measurement (for example, received signal strength, SNR, and SINR of the signal for measurement) to the base station at S209 and S211. The base station may determine start/release of the device-to-device communications based on the information include in the measurement report message at S212. For example, when result information included in the measurement report message is equal to or above a predefined threshold, the base station may determine a start of the device-to-device communication. On the contrary, when result information included in the measurement report message is below a predefined threshold, the base station may determine a release of the device-to-device communication. Here, the predefined threshold may be a minimal signal strength or minimal distance which makes device-to-device communications between the first terminal and the second terminal possible.

After the base station determines start or release of device-to-device communications, the base station may transmit a D2D measurement report message including information on determination of start/release of device-to-device communications and a pair identifier to the MME. The D2D measurement report message may be transmitted to the PGW sequentially through the MME and the SGW at S213.

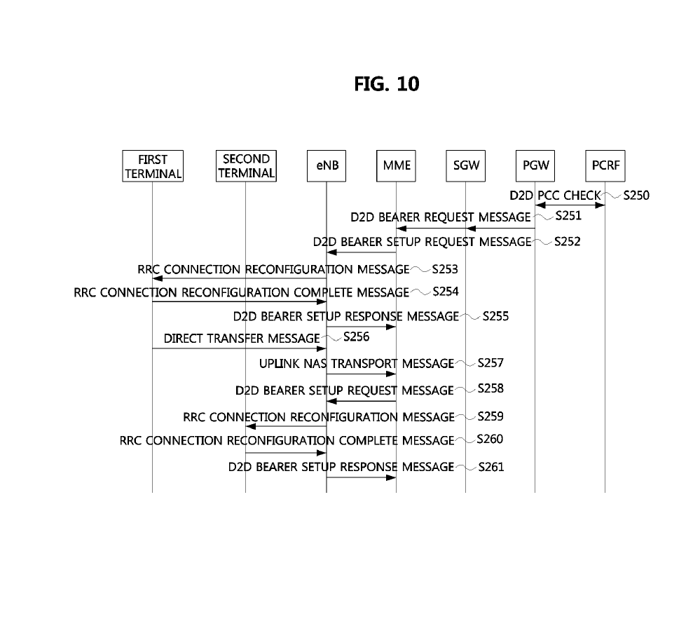

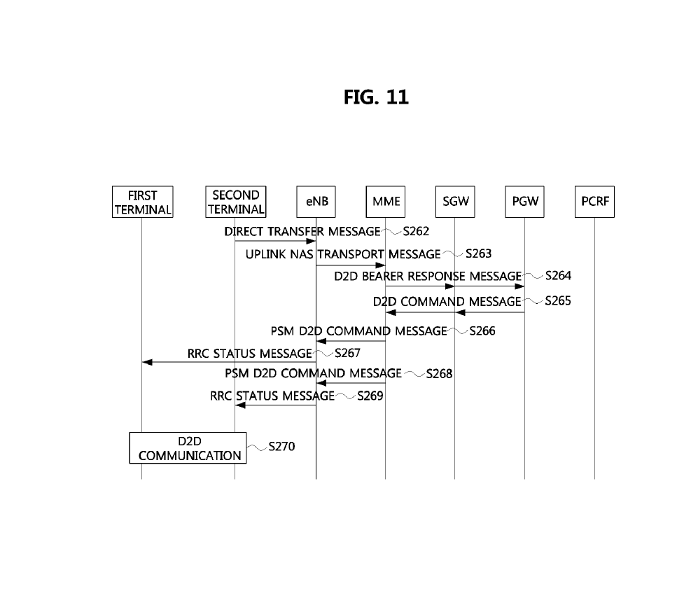

FIG. 10 is a flow chart to illustrate a first step of a procedure of configuring device-to-device communications according to an example embodiment of the present invention, and FIG. 11 is a flow chart to illustrate a second step of a procedure of configuring device-to-device communications according to an example embodiment of the present invention.

Referring to FIGS. 10 and 11, the procedure of configuring device-to-device communications may mean the step S155 depicted in FIG. 8. When the PGW receives the D2D communication start request message from the D2D server, the PGW may perform PCC checks of the first terminal and the second terminal which desire to perform device-to-device communications by communicating with the PCRF at S250. After the PGW performs PCC checks, the PGW may start a procedure of configuring a D2D bearer for device-to-device communications by transmitting a D2D bearer request message to the SGW. The SGW may transmit a D2D bearer request message to the MME at S251. The D2D bearer request message may include a pair identifier and so on.

After the D2D bearer request message is received, the MME may select an identifier of a D2D bearer. Here, the identifier of D2D bearer may be local information within a terminal. Also, the MME may configure a ProSe management (PSM) information of non-access stratum (NAS) level for the first terminal. Here, the PSM information may include the pair ID, the D2D bearer ID, a D2D bearer QoS, a D2D bearer traffic flow template (TFT), and so on. The MME transmit a D2D bearer setup request message including the PSM information to the base station at S252.

When the D2D bearer setup request message for the first terminal is received, the base station may map the D2D bearer QoS included in the D2D bearer setup request message to a D2D radio bearer QoS. Then, the base station may transmit a RRC connection reconfiguration message to the first terminal at S253. Here, the RRC connection reconfiguration message may include a D2D resource block ID, the D2D radio bearer QoS, the PSM information, and so on.

When the RRC connection reconfiguration message is received, the first terminal may store the D2D resource block ID, the D2D bearer TFT, and so on. Then, the first terminal may notify generation of a D2D radio bearer by transmitting a RRC connection reconfiguration complete message to the base station at S254.

When the RRC connection reconfiguration complete message is received, the base station notify generation of the D2D radio bearer by transmitting a D2D bearer setup response message to the MME at S255. Here, the D2D bearer setup response message may include the pair ID, the D2D bearer ID, and so on.

Meanwhile, a NAS of the first terminal may configure a pair ID and a PSM response information including the D2D bearer ID, and transmit a direct transfer message including the PSM response information to the base station at S256. When the direct transfer message is received, the base station may configure an uplink NAS transport message based on the PSM response information included in the direct transfer message, and transmit the uplink NAS transport message to the MME at S257.

Also, the MME may configure a ProSe management (PSM) information of non-access stratum (NAS) level for the second terminal when the D2D bearer request message is received. Here, the PSM information may include a pair ID, a device-to-device bearer ID, a device-to-device bearer QoS, a device-to-device bearer traffic flow template (TFT), and so on.

The MME transmit a D2D bearer setup request message including the PSM information to the base station at S258.

When the D2D bearer setup request message for the second terminal is received, the base station may map a D2D bearer QoS included in the D2D bearer setup request message to a D2D radio bearer QoS. Then, the base station may transmit a RRC connection reconfiguration message to the second terminal at S259. Here, the RRC connection reconfiguration message may include a D2D resource block ID, a D2D radio bearer QoS, a PSM information, and so on.

When the RRC connection reconfiguration message is received, the second terminal may store the D2D resource block ID, the D2D bearer TFT, and so on. Then, the second terminal may notify generation of a D2D radio bearer by transmitting a RRC connection reconfiguration complete message to the base station at S260.

When the RRC connection reconfiguration complete message is received, the base station notify generation of a D2D radio bearer by transmitting a D2D bearer setup response message to the MME at S261. Here, the D2D bearer setup response message may include a pair ID, a D2D bearer ID, and so on.

Meanwhile, a NAS of the second terminal may configure a pair ID and a PSM response information including a D2D bearer ID, and transmit a direct transfer message include the PSM response information to the base station at S262. When the direct transfer message is received, the base station may configure an uplink NAS transport message based on the PSM response information included in the direct transfer message, and transmit the uplink NAS transport message to the MME at S263.

When the D2D bearer setup response message and the uplink NAS transport message (that is, PSM response information) for the first terminal and the second terminal are received, the MME may identify that configuration of device-to-device communication for all the terminals are completed. Then, the MME may transmit a D2D bearer response message in response to the D2D bearer request message (that is, S251) to the SGW. The SGW may transmit the received D2D bearer response message to the PGW at S264. The D2D bearer response message may include a pair ID, a D2D bearer ID, and so on.

Here, an example in which the steps S252 to S257 of configuring D2D bearer for the first terminal are performed before the steps S258 to S261 for the second terminal was explained. However, the performing order of the steps is not limited to the above example. In other words, the steps for the first terminal and the steps for the second terminal may be performed at the same time. Alternatively, the steps for the first terminal may be performed after the steps for the second terminal are performed.

When the D2D bearer response message is received, the PGW may determine that the pair is capable of performing D2D scheduling. Accordingly, the PGW may transmit a D2D command message to the SGW. The SGW may transmit the received D2D command message to the MME at S265. The D2D command message may include a pair ID, and so on.

When the D2D command message is received, the MME may transmit a PSM D2D command message for the first terminal and the second terminal to the base station at S266 and S268. When the PSM D2D command message is received, the base station may start a L2 scheduling. In other words, the base station may configure a traffic flow of application with the D2D radio bearer by using a D2D packet filter of a D2D bearer TFT included in the PSM information received through the S252 and S258. The base station may transmit a RRC status message including information on configured D2D radio bearer to each terminal at S267 and S269. That is, the base station may instruct each terminal to start a D2D communication by transmitting the RRC status message.

When the RRC status message is received, the terminal may perform device-to-device communications using a radio bearer indicated by the RRC status message at S270.

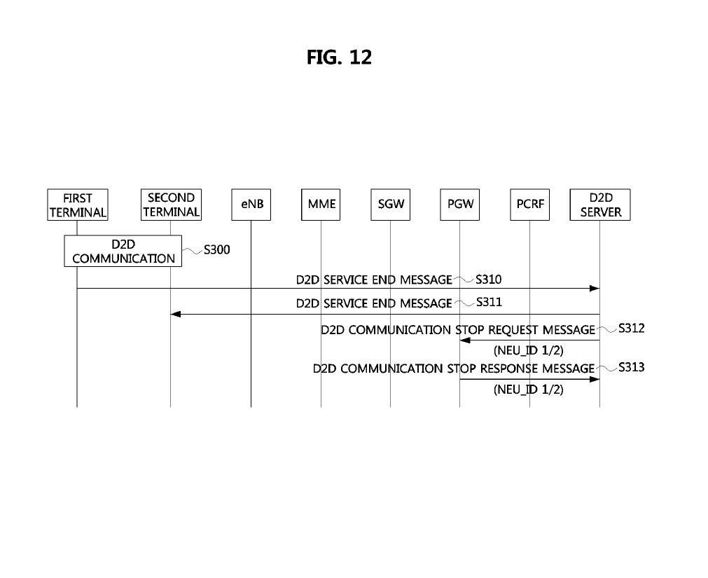

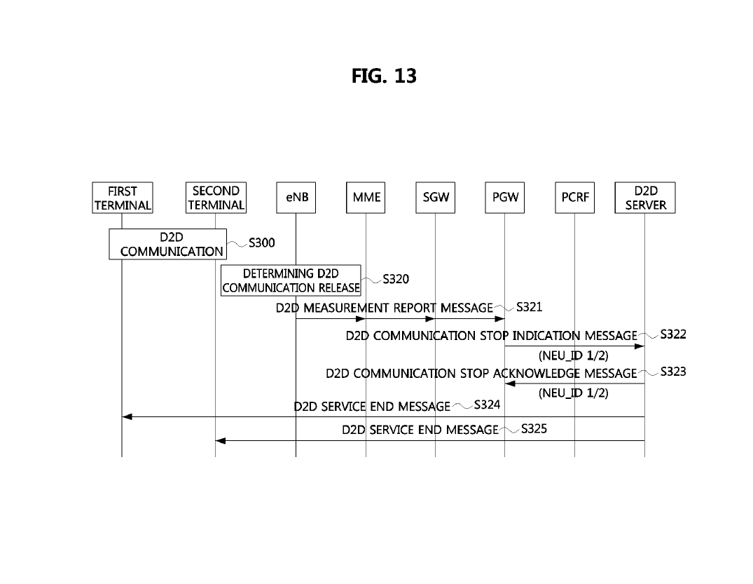

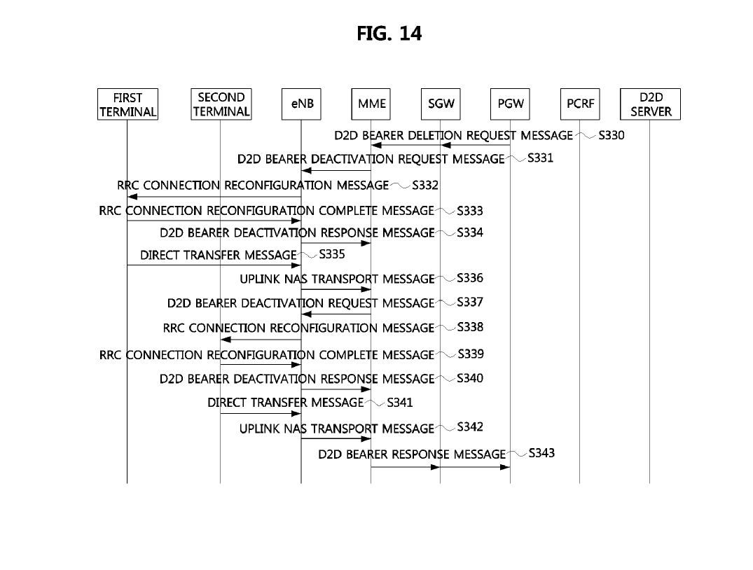

FIG. 12 is a flow chart to illustrate a procedure of releasing D2D communications initiated by a user according to an example embodiment of the present invention, and FIG. 13 is a flow chart to illustrate a procedure of releasing D2D communications initiated by a base station according to an example embodiment of the present invention, and FIG. 14 is a flow chart to illustrate a procedure of releasing D2D bearer according to an example embodiment of the present invention.

Referring to FIGS. 12 to 14, a procedure of releasing D2D communications may be classified into a user initiated procedure of releasing D2D communications and a base station initiated procedure of releasing D2D communications.

First, in the procedure of releasing D2D communications initiated by a user, at S310, a user of the first terminal may transmit a D2D service end message to a device-to-device server through the first terminal when the user wants to release D2D communications. When the D2D service end message is received, the D2D server may transmit a D2D service end message to the second terminal which is performing D2D communications with the first terminal so as to inform an end of D2D service at S311.

Then, the D2D server may request release of D2D communications between the first terminal and the second terminal by transmitting a D2D communication stop request message to the PGW at S312. At S313, the PGW may transmit a D2D communication stop response message to the D2D server in response to the D2D communication stop request message. The D2D communication stop request message may include the network ID of the first terminal network ID, the network ID of the second terminal, and so on. The D2D communication stop response message may include the network ID of the first terminal network ID, the network ID of the second terminal, and so on.

Second, in the procedure of releasing D2D communications initiated by a base station, at S320, the base station may determine whether D2D communications between the first terminal and the second terminal are possible based on the proximity measurement result. Here, the proximity measurement for the first terminal and the second terminal may be performed through the steps explained in FIG. 9.

When the base station determines that D2D communications between the first terminal and the second terminal are impossible, the base station may notify a start of release of D2D communications by transmitting a D2D measurement report message to the MME. At S321, the D2D measurement report message may be transmitted to the PGW sequentially through the MME and the SGW. The D2D measurement report message may include a proximity measurement result, a pair ID, and so on.

When the D2D measurement report message is received, the PGW may notify a start of release of D2D communications by transmitting a D2D communication stop indication message to the D2D server at S322. The D2D communication stop indication message may include the network ID of the first terminal, the network ID of the second terminal, and so on. The D2D server may transmit a D2D communication stop acknowledge message in response to the D2D communication stop indication message to the PGW at S323. Then, the D2D server may notify an end of D2D service by transmitting a D2D service end message to the first terminal and the second terminal at S324 and S325.

In the procedure of releasing D2D communications, the below procedures of releasing D2D bearer may be performed after the step S313 in the procedure of releasing D2D communication initiated by a user and the step S325 in the procedure of releasing D2D communication initiated by a base station.

When the D2D communication stop request message is received at S312 or the D2D communication stop acknowledge message is received at S323, the PGW may transmit a D2D bearer deletion request message to the SGW. The SGW may transmit a D2D bearer deletion request message to the MME at S330. The D2D bearer deletion request message may include a pair ID, a D2D bearer ID, and so on.

When the D2D communication stop request message is received, the MME may configure a ProSe management (PSM) information of NAS level for the first terminal. The PSM information may include a pair ID, a D2D bearer ID, and so on. The MME may transmit a D2D bearer deactivation request message including the PSM information to the base station at S331.

When the base station receives the D2D bearer deactivation request message, the base station may transmit a RRC connection reconfiguration message to the first terminal at S332.

In other words, the base station may request a release of D2D bearer by transmitting the RRC connection reconfiguration message to the first terminal. The RRC connection reconfiguration message may include a D2D resource block ID, the PSM information, and so on.

When the RRC connection reconfiguration message is received, the first terminal may release D2D bearer and D2D radio bearer, and transmit a RRC connection reconfiguration complete message indicating that D2D radio bearer is released to the base station at S333. In response to the D2D bearer deactivation request message, the base station may transmit a D2D bearer deactivation response message indicating that D2D radio bearer is released to the MME at S334. The D2D bearer deactivation response message may include a pair ID, a D2D bearer ID, and so on.

In addition, the first terminal may configure a PSM information including the pair ID, the D2D bearer ID, and the like. Then, the first terminal may transmit a direct transfer message including the PSM information to the base station at S335. When the direct transfer message is received, the base station may an uplink NAS transport message including the ProSe management information to the MME at S336.

When the D2D bearer deletion request message is received, the MME may configure a PSM management information of NAS level for the second terminal. The PSM information may include a pair ID, a D2D bearer ID, and so on. The MME may transmit a D2D bearer deactivation request message including the PSM information to the base station at S337.

When the base station receives the D2D bearer deactivation request message, the base station may transmit a RRC connection reconfiguration message to the second terminal at S338. In other words, the base station may request a release of D2D bearer by transmitting the RRC connection reconfiguration message to the second terminal. The RRC connection reconfiguration message may include a D2D resource block ID, the PSM information, and so on.

When the RRC connection reconfiguration message is received, the second terminal may release D2D bearer and D2D radio bearer, and transmit a RRC connection reconfiguration complete message indicating that D2D radio bearer is released to the base station at S339. In response to the D2D bearer deactivation request message, the base station may transmit a D2D bearer deactivation response message indicating that D2D radio bearer is released to the MME at S340. The D2D bearer deactivation response message may include a pair ID, a D2D bearer ID, and so on.

In addition, the second terminal may configure a PSM information including the pair ID, the D2D bearer ID, and the like. Then, the second terminal may transmit a direct transfer message including the PSM information to the base station at S341. When the direct transfer message is received, the base station may transmit an uplink NAS transport message including the PSM information to the MME at S342.

When the D2D bearer deactivation response messages and the PSM response information for all the terminals are received, the MME may be informed that D2D communications between the first terminal and the second terminal are released. Accordingly, the MME may transmit a D2D bearer deletion response message in response to the D2D bearer deletion request message to the SGW. The SGW may transmit the D2D bearer deletion request message to the PGW at S343. The D2D bearer deletion request message may include a pair ID, a D2D bearer ID, and so on.

Here, an example in which the steps S331 to S336 of reconfiguring D2D bearer for the first terminal are performed before the steps S337 to S342 for the second terminal was explained. However, the performing order of the steps is not limited to the above example. In other words, the steps for the first terminal and the steps for the second terminal may be performed at the same time. Alternatively, the steps for the first terminal may be performed after the steps for the second terminal are performed.

The open-type discovery based services are services based on a discovery that a discovery terminal can discover a discoverable terminal without reciprocal agreement. The discoverable terminal may perform registration for the open-type discovery, and perform transmission of discovery information. The discovery terminal may receive discovery information transmitted from the discovery terminal, and obtain information on services desired by a user. After the discoverable terminal is discovered, the service using D2D communications may be selected by the user. The representative open-type discovery based service is a commercial advertisement service.

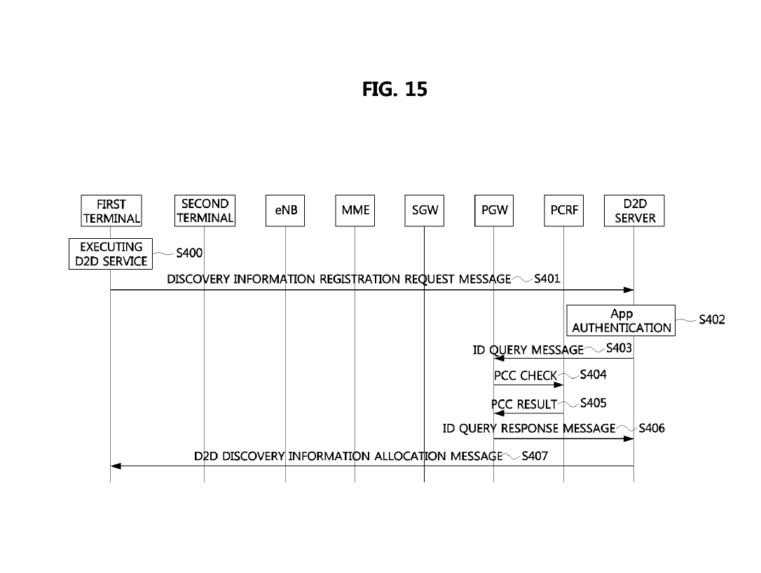

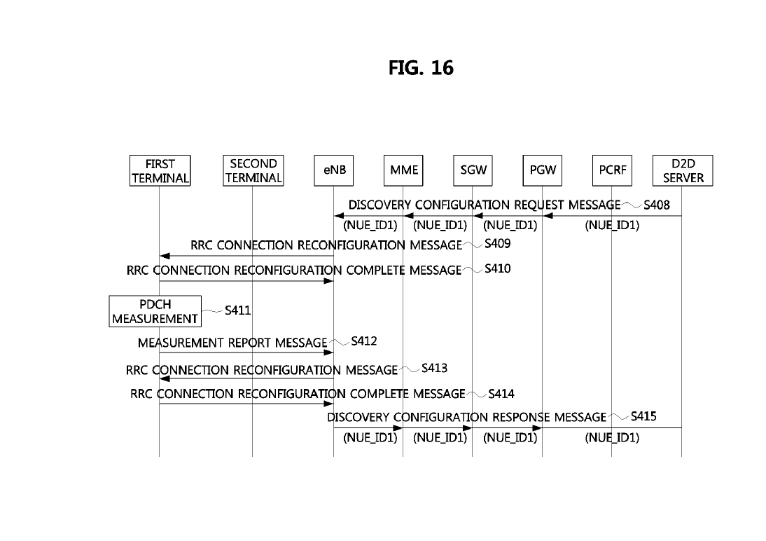

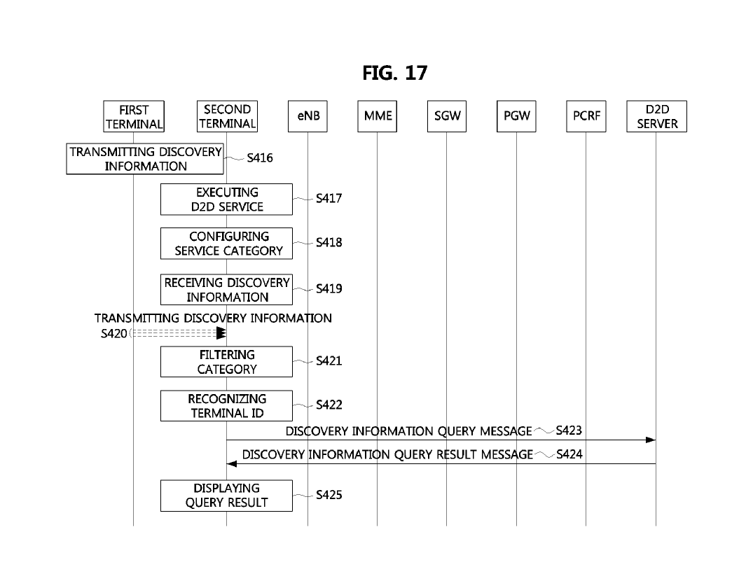

FIG. 15 is a flow chart of a first step of an open-type discovery procedure according to an example embodiment of the present invention, and FIG. 16 is a flow chart of a second step of an open-type discovery procedure according to an example embodiment of the present invention, and FIG. 17 is a flow chart of a third step of an open-type discovery procedure according to an example embodiment of the present invention.

Referring to FIGS. 15 to 17, the first terminal (that is, the discovery terminal) which executed a D2D service by a user request may register information of the second terminal (that is, the discoverable terminal) by transmitting a discovery information registration request message to the D2D server at S401. The discovery information registration request message may include a service category, a telephone number, an application ID, and other information (for example, URL, basic menu, etc.) of the first terminal.

When the discovery information registration request message is received, the D2D server may perform authentication on application at S402. Then, the D2D server may transmit an ID query message to the PGW at S403. In other words, the step of transmitting the ID query message may be performed for obtaining a unique network ID identifying the first terminal in a 3GPP network based on the telephone number of the first terminal.

When the ID query message is received, the PGW may perform procedures for checking PCC with the PCRF at S404 and S405. After the PCC check procedure is performed, the PGW may transmit a network ID of the first terminal (such as an IMSI, an IP address, and so on) in response to the ID query message to the D2D server at S406.

The D2D server may allocate discovery information for the first terminal which will be transmitted through a physical discovery channel, and transmit a D2D discovery information allocation message including the allocated discovery information to the first terminal at S407. The discovery information may include an ID of the first terminal (for example, ‘A100’), a service category of the first terminal (for example, ‘D3F2’), and so on.

The D2D server may start a procedure of transmitting discovery information of the first terminal through the physical discovery channel by transmitting a discovery configuration request message including the network ID of the first terminal to the PGW. At S408, the discovery configuration request message may be transmitted to the base station sequentially through the PGW, the SGW, and the MME.

When the discovery configuration request message is received, the base station may transmit a RRC connection reconfiguration message for measuring state of physical discovery channel to the first terminal at S409. The first terminal may transmit a RRC connection reconfiguration complete message in response to the received RRC connection reconfiguration message to the base station at S410. Then, the first terminal may perform measurement on the state of the physical discovery channel (PDCH) based on configuration information included in the RRC connection reconfiguration message at S411.

The first terminal may transmit a measurement report message including measurement result of the PDCH to the base station at S412. The base station may determine radio resources used for transmitting discovery information based on the measurement result of the PDCH, and transmit a RRC connection reconfiguration message including information on the determined radio resources to the first terminal at S413. The first terminal may transmit a RRC connection reconfiguration complete message in response to the RRC connection reconfiguration message to the base station at S414.

Then, the base station may notify completion of configuring transmission of discovery information of the second terminal by transmitting a discovery configuration response message to the MME in response to the discovery configuration request message. At S415, the discovery configuration response message may be transmitted to the D2D server sequentially through the MME, the SGW, and the PGW. The discovery configuration response message may include a network ID of the first terminal. The first terminal may transmit discovery information through the PDCH after transmitting a RRC connection reconfiguration complete message at S416 and S420.

Meanwhile, the second terminal may perform a D2D service at S417, and configure a service category (for example, ‘D3F2’) which the second terminal desires to discover at S418.

Then, the second terminal may receive discovery information transmitted through the PDCH at S419, and obtain an ID of a terminal which transmits discovery information corresponding to the service category desired by the second terminal by service category filtering at S421 and S422. When the ID of the terminal which transmits discovery information corresponding to the service category desired by the second terminal is obtained, the second terminal may transmit a discovery information query message for obtaining detail information of the discovery information to the D2D server at S423. The discovery information query message may include the ID of the terminal which transmitted the discovery information.

The D2D server may transmit a discovery information query result message in response to the discovery information query message to the second terminal at S424. The discovery information query result message may include detail information of the discovery information (such as URL, basic menu, and so on). The second terminal may display the detail information for a user of the second terminal at S425.

In the open-type discovery, a user of a terminal may select a discovery ID (discovery information) which the terminal transmits. In this case, the discovery ID selected by the user may be transmitted to the D2D server. The D2D server may check whether the selected discovery ID is redundant or not, and inform the terminal whether D2D service is acknowledged or not.

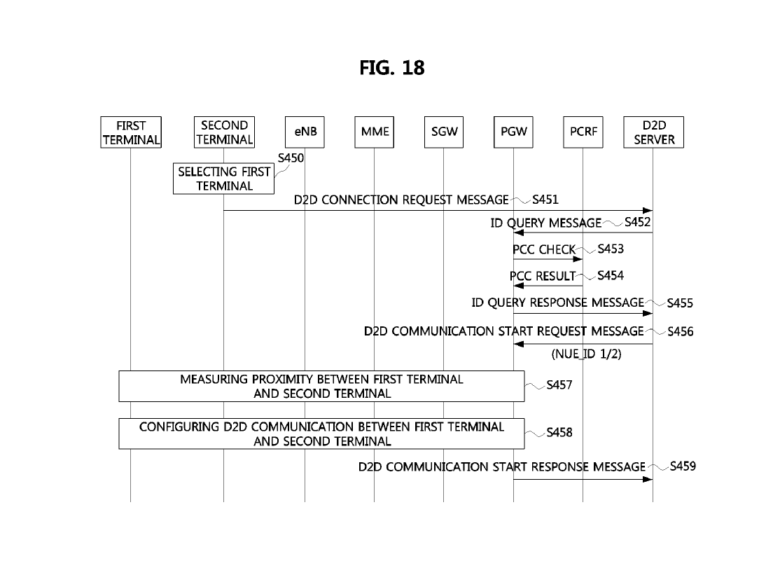

FIG. 18 is a flow chart to illustrate a procedure of configuring D2D connection in an open-type discovery according to an example embodiment of the present invention. Referring to FIG. 18, the second terminal (that is, the discovery terminal) may transmit a D2D connection request message based on discovery information obtained through the open-type discovery procedures to the D2D server at S451. The D2D connection request message may include discovery information of the first terminal (for example, A100) and an ID of the second terminal (for example, a telephone number).

When the D2D connection request message is received, the D2D server may request an ID of the second terminal by transmitting an ID query message to the PGW at S452. The step of transmitting the ID query message may be performed for obtaining a unique network ID identifying the second terminal in a 3GPP network based on the telephone number of the second terminal.

When the ID query message is received, the PGW may perform procedures for checking PCC with a PCRF at S453 and S454. After the PCC check procedure is performed, the PGW may transmit a network ID of the second terminal (such as an IMSI, an IP address, and so on) in response to the ID query message to the D2D server at S455.

When the ID query response message is received, the D2D server may start a procedure of configuring D2D connection for D2D communications between the first terminal and the second terminal by transmitting a D2D communication start request message to the PGW at S456. The D2D communication start request message may include a network ID of the first terminal and a network ID of the second terminal.

When the D2D communication start request message is received, the PGW may perform a procedure of measuring proximity in order to determine whether D2D communications between the first terminal and the second terminal are possible of not at S457. Here, the procedure of measuring proximity may be identical to the procedure explained by referring to FIG. 9.

When D2D communications between the first terminal and the second terminal are determined to be possible, a procedure of configuring D2D communications between the first terminal and the second terminal may be performed at S458. Here, the procedure of configuring D2D communications may be identical to the procedure explained by referring to FIGS. 10 and 11.

When the configuration of D2D communications between the first terminal and the second terminal is completed, the PGW may transmit a D2D communication start response message in response to the D2D communication start request message to the D2D server at S459. The D2D communication start response message may include the network ID of the first terminal and the network ID of the second terminal.

According to the present invention, a procedure of discovery may be performed when a discovery terminal and a discoverable terminal are located within a distance in which D2D communications are possible. Thus, the procedure of discovery may be performed efficiently.

While the example embodiments of the present invention and their advantages have been described in detail, it should be understood that various changes, substitutions and alterations may be made herein without departing from the scope of the invention.

What is claimed is:

1. A method for device-to-device discovery, performed in a device-to-device server supporting device-to-device discovery between a discovery terminal and a discoverable terminal, comprising:
receiving a device-to-device discovery participation message from the discoverable terminal;
requesting a gateway to measure proximity between the discovery terminal and the discoverable terminal;
receiving a proximity measurement result from the gateway; and
requesting the discovery terminal and the discoverable terminal to initiate a procedure of device-to-device discovery when the proximity measurement result satisfies a predetermined threshold.

2. The method for device-to-device discovery according to claim 1, further comprising allocating a physical channel for device-to-device discovery for the discovery terminal and the discoverable terminal after the requesting the discovery terminal and the discoverable terminal to initiate a procedure of device-to-device discovery.

3. The method for device-to-device discovery according to claim 1, wherein the device-to-device discovery participation message indicates that the discoverable terminal participates in the procedure of device-to-device discovery requested by the discovery terminal.

4. The method for device-to-device discovery according to claim 1, wherein the gateway is a Packet Data Network (PDN) gateway (PGW).

5. The method for device-to-device discovery according to claim 1, wherein the proximity is measured based on received signal strength of reference signals transmitted and received between the discovery terminal and the discoverable terminal.

6. The method for device-to-device discovery according to claim 1, wherein the proximity is measured based on positional information of the discovery terminal and positional information of the discoverable terminal.

7. The method for device-to-device discovery according to claim 1, wherein the predetermined threshold is determined based on a minimal distance which makes device-to-device communications between the discovery terminal and the discoverable terminal possible.

8. A method for device-to-device discovery, performed in a device-to-device server supporting device-to-device discovery between a discovery terminal and a discoverable terminal, comprising:
receiving device-to-device communication initiation request messages from the discovery terminal and the discoverable terminal;
transmitting a device-to-device communication configuration request message requesting a gateway to configure device-to-device communications between the discovery terminal and the discoverable terminal; and
receiving a device-to-device communication configuration response message indicating a completion of configuration of device-to-device communications between the discovery terminal and the discoverable terminal from the gateway when a proximity measurement result satisfies a predetermined threshold.

9. The method for device-to-device discovery according to claim 8, wherein the device-to-device communication initiation request messages are received from the discovery terminal which recognized the discoverable terminal and from the discoverable terminal which recognized the discovery terminal

10. The method for device-to-device discovery according to claim 8, wherein the gateway is a Packet Data Network (PDN) gateway (PGW).

11. The method for device-to-device discovery according to claim 8, wherein the device-to-device communication configuration request messages include a network identifier of the discovery terminal and a network identifier of the discoverable terminal.

12. The method for device-to-device discovery according to claim 8, wherein the proximity is measured based on received signal strength of reference signals transmitted and received between the discovery terminal and the discoverable terminal.

13. The method for device-to-device discovery according to claim 8, wherein the proximity is measured based on positional information of the discovery terminal and positional information of the discoverable terminal.

14. The method for device-to-device discovery according to claim 8, wherein the predetermined threshold is determined based on a minimal distance which makes device-to-device communications between the discovery terminal and the discoverable terminal possible.

15. A method for measuring proximity between terminals, performed in a base station, comprising:
allocating radio resources for transmitting a reference signal for measuring proximity to a first terminal;
allocating radio resources for receiving the reference signal for measuring proximity to a second terminal;
obtaining information on measurement result of the reference signal from the second terminal; and
determining whether to start device-to-device communications between the first terminal and the second terminal based on the information on measurement result of the reference signal.

16. The method for measuring proximity between terminals according to the claim 15, wherein the base station allocates radio resources for transmitting the reference signal for measuring proximity based on a request of a device-to-device server.

17. The method for measuring proximity between terminals according to the claim 15, wherein the information on measurement result of the reference signal includes the received signal strength of the reference signal.

18. The method for measuring proximity between terminals according to the claim 17, wherein the device-to-device communications between the first terminal and the second terminal are determined to be started when the received signal strength of the reference signal is equal to or above a predetermined threshold.

19. The method for measuring proximity between terminals according to the claim 17, wherein the device-to-device communications between the first terminal and the second terminal are determined to be released when the received signal strength of the reference signal is below a predetermined threshold.

20. The method for measuring proximity between terminals according to the claim 18, wherein the predetermined threshold is a minimal signal strength which makes the device-to-device communications between the first terminal and the second terminal possible.
